(19) United States
(12) Patent Application Publication
(10) Pub. No.: US 2020/0409369 A1
(43) Pub. Date: Dec. 31, 2020

(54) System and Methods for Autonomous Vehicle Testing

(71) Applicant: UATC, LLC, San Francisco, CA (US)

(72) Inventors: Vladimir Zaytsev, San Francisco, CA (US); Mark Yen, San Francisco, CA (US)

(21) Appl. No.: 16/723,340

(22) Filed: Dec. 20, 2019

Related U.S. Application Data
(60) Provisional application No. 62/866,279, filed on Jun. 25, 2019.

(51) Int. Cl. G05D 1/02; G05D 1/00; G01C 21/34; G01C 21/36; G06F 9/455

(52) U.S. Cl. CPC G05D 1/0212; G05D 1/0088; G05D 2201/0213; G01C 21/3605; G06F 9/455; G01C 21/3438

(57) ABSTRACT

The present disclosure is directed to autonomous vehicle service assignment simulation using predefined scenarios. In particular a computing system comprising one or more computing devices can obtain data associated with a simulated autonomous vehicle within a simulation environment based at least in part on the predefined scenario. The computing system can initiate a simulation of the predefined scenario using the data associated with the simulated autonomous vehicle to perform the predefined scenario within the simulation environment. The computing system can receive one or more simulated events to attempt to complete the predefined scenario. The computing system can determine whether the autonomous vehicle has successfully completed the predefined scenario.

### RELATED APPLICATION

This application claims priority to and the benefit of U.S. Provisional Patent Application No. 62/866,279, filed Jun. 25, 2019, which is hereby incorporated by reference in its entirety.

### FIELD

The present disclosure relates generally to autonomous vehicles. More particularly, the present disclosure relates to using simulation systems to test autonomous vehicles.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path for navigating through such surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a computing system comprising one or more computing devices, data indicative of an autonomous vehicle to be tested within a simulation associated with a service entity. The method can also include identifying, by the computer system, a predefined scenario for the autonomous vehicle to be tested within the simulation. The method can also include generating, by the computing system, a simulated autonomous vehicle within a simulation environment based at least in part on the data indicative of the autonomous vehicle and the predefined scenario. The method can also include initiating, by the computing system, a simulation of the predefined scenario using the simulated autonomous vehicle to perform the predefined scenario within the simulation environment. The method can also include providing, by the computing system, the simulated autonomous vehicle access to one or more services of the one or more backend systems of the service entity during the simulation. The method can also include receiving, by the computer system, one or more simulated events, the simulated events enabling the simulated autonomous vehicle to attempt to complete the predefined scenario. The method can also include determining, by the computer system, based on one or more criteria whether the autonomous vehicle has successfully completed the predefined scenario.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example system for controlling the navigation of a vehicle according to example embodiments of the present disclosure;

FIG. 2 depicts an example entity infrastructure according to example embodiments of the present disclosure;

FIG. 3 depicts an example vehicle service test system infrastructure according to example embodiments of the present disclosure;

FIG. 4 depicts an example entity infrastructure according to example embodiments of the present disclosure;

FIGS. 5A and 5B depict state machine diagrams according to example embodiments of the present disclosure;

FIG. 6 depict state machine diagrams according to example embodiments of the present disclosure;

FIGS. 7A-7E depict example data flow diagrams according to example embodiments of the present disclosure;

FIG. 8 depicts a flow diagram of an example method for predefined scenario simulations according to example embodiments of the present disclosure; and

FIG. 9 depicts an example system with units for performing operations and functions according to example aspects of the present disclosure; and

FIG. 10 depicts example system components according to example aspects of the present disclosure.

### DETAILED DESCRIPTION

Generally, the present disclosure is directed to improved techniques for simulating the end-to-end distribution and performance of a service assignment by an autonomous vehicle via a service entity infrastructure. For instance, an autonomous vehicle can drive, navigate, operate, etc. with minimal and/or no interaction from a human driver to provide a vehicle service. By way of example, an autonomous vehicle can be configured to autonomously provide transportation and/or other services, such as transporting a user (e.g., passenger) from a first location to a second location. The user can request this transportation service with a service entity, which can create a service assignment for an autonomous vehicle. In some implementations, the service entity can utilize its own fleet of autonomous vehicles to perform a service assignment. The service entity can also have an infrastructure that can allow the service entity to assign the service assignment to an autonomous vehicle of another entity's fleet (e.g., “a third-party autonomous vehicle”).

The systems and methods of the present disclosure provide improved techniques to simulate an autonomous vehicle interacting with the service entity infrastructure. More particularly, a simulation system stores, or receives, a plurality of predefined scenarios, each scenario representing a multi-step (or multi-state) task which may be performed by third party autonomous vehicles through the service entity within an isolated simulation environment (e.g., a sandbox). For example, a third-party entity may want to test whether the autonomous vehicles in the third-party entity's fleet of autonomous vehicles correctly perform a specific service assignment (e.g., pick-up a passenger from a first location and drop the passenger off at a second location.) To test this specific task, a user associated with the third-party entity can request that the simulation system create a simulation (e.g., using an application at a computing device associated with the third party/user). The user can request a simulation of an autonomous vehicle associated with the third-party entity and a simulated environment in which to run the simulation. The user can also select a predefined scenario from a plurality of potential predefined scenarios. In response to the request, the simulation system can initiate a simulated environment and populate it with a simulated autonomous vehicle and one or more simulated actors. The simulated system can engage a scenario simulation system to simulate a multi-step task associated with the selected predefined scenario.

Once the simulation has been initiated, the scenario simulation service can access information about the predefined scenario and generate one or more events to simulate the selected scenario. When an event is received, the simulated autonomous vehicle can respond within the simulated environment as if the simulated event were real. The scenario simulation system can monitor the events and the responses of the simulated autonomous vehicle as the autonomous vehicle moves through each step of the multi-step process. In the example of a scenario that includes transporting a simulated rider, the steps may include receiving a ride request, accepting the request, navigating the simulated environment to the pickup location, allowing the rider to enter the autonomous vehicle, navigating the simulated environment to the drop-off location, and completing the scenario by successfully dropping off the rider. If any of the steps are not successfully completed, the scenario simulation system can determine that the autonomous vehicle has failed to successfully complete the scenario. This information can be recorded for later analysis. By pre-defining these scenarios, the simulation system can avoid the difficulty of manual programming for each simulation while providing consistency across testing sessions and tested autonomous vehicles. This can allow potential problems to be identified before the service entity or third-party autonomous vehicles are used in live testing and/or for actual service performance. Ultimately, the technology described herein can allow autonomous vehicles to use the predefined scenarios to thoroughly test autonomous vehicles in a safe, isolated, and consistent testing environment.

Although the following overview describes the use of simulated autonomous vehicles in various example embodiments, the systems and methods of the present disclosure can also be utilized with real-world autonomous vehicle deployed within a geographic area. Moreover, while several examples are described with respect with third party entities and third-party autonomous vehicles, such implementations can also be utilized by a service entity and the autonomous vehicles associated with the service entity.

More particularly, a service entity (e.g., service provider, owner, manager, platform) can use one or more vehicles (e.g., ground-based vehicles such as automobiles, trucks, bicycles, scooters, other light electric vehicles, etc.; flight vehicles; and/or the like) to provide a vehicle service such as a transportation service (e.g., rideshare service), a courier service, a delivery service, etc. For example, the service entity (e.g., via its operations computing system) can receive requests for vehicle services (e.g., from a user) and generate service assignments (e.g., indicative of the vehicle service type, origin location, destination location, and/or other parameters) for the vehicle(s) to perform. The vehicle(s) can be autonomous vehicles that include various systems and devices configured to control the operation of the vehicle. For example, an autonomous vehicle can include an onboard vehicle computing system for operating the autonomous vehicle (e.g., located on or within the autonomous vehicle). The vehicle computing system can obtain sensor data from sensor(s) onboard the vehicle (e.g., cameras, LIDAR, RADAR), attempt to comprehend the vehicle's surrounding environment by performing various processing techniques on the sensor data, and generate an appropriate motion plan through the vehicle's surrounding environment. Moreover, an autonomous vehicle can be configured to communicate with one or more computing devices that are remote from the vehicle. For example, the autonomous vehicle can communicate with a remote computing system that can be associated with the entity, such as the entity's operations computing system. The operations computing system can include a plurality of system clients that can help the service entity monitor, communicate with, manage, etc. autonomous vehicles. In this way, the service entity can manage the autonomous vehicles to provide the vehicle services of the entity.

The autonomous vehicles utilized by the service entity to provide the vehicle service can be associated with a fleet of that service entity or a third-party. For example, the service entity may own, lease, etc. a fleet of autonomous vehicles that can be managed by the service entity (e.g., via system clients) to provide one or more vehicle services. In some implementations, an autonomous vehicle can be associated with a third-party entity such as, for example, an individual, an original equipment manufacturer (OEM), or another entity (e.g., a “third-party autonomous vehicle”). Even though such an autonomous vehicle may not be included in the fleet of autonomous vehicles of the service entity, the platforms of the present disclosure can allow such a third-party autonomous vehicle to still be utilized to provide the vehicles services offered by the service entity, access the service entity system clients, etc.

The service entity's infrastructure can include an offboard trip testing (OTT) system that can help verify that autonomous vehicles (e.g., third-party autonomous vehicles, etc.) are able to fully utilize the backend services (e.g., system clients) of the infrastructure as well as to complete service assignments of the service entity. The OTT system can be configured to simulate the end-to-end distribution, performance, and completion of a service assignment by an autonomous vehicle via the entity's infrastructure. For example, the OTT system can create a simulated service assignment (e.g., to transport a simulated user), assign the simulated service assignment to simulated autonomous vehicle (e.g., representative of the third-party autonomous vehicle), and monitor the performance of the simulated autonomous vehicle. The simulated autonomous vehicle can be provided access to the backend services of the entity's infrastructure while completing the service assignment within the simulated environment. Moreover, the OTT system can provide a graphical user interface that allows a human user to study the performance of the simulated autonomous vehicle. The OTT system can include various sub-systems that allow the OTT system to run test simulations and present the results of the simulation.

One sub-system that can be included in the OTT system is a scenario simulation system. The scenario simulation system is a sub-system that can provide the simulation system the ability to simulate specific predefined scenarios. As further described herein, the predefined scenarios can include simulation scenarios that are configured prior to the initiation of a simulation. Simulating specific scenarios can enable a third-party to test, in a safe simulated environment, very specific events and potential problems associated with the specific predefined scenario. A scenario simulation system can include a scenario state queue data structure, a scenario progress tracking system, a scenario data store, and a scenario repository. In some examples, the scenario simulation system can include a scenario repository that stores data associated with a plurality of predefined scenarios that be designated to simulate a task associated with the predefined scenario. In some examples, the scenario state queue data structure is a queue data structure (e.g., a first-in first-out queue) that is populated with data representing a list of states associated with completing a selected scenario. The scenario progress tracking system can access data for a first state in a multi-step process, transmit accessed data to a simulation system, and track the current state of the scenario simulation. In some examples, the scenario progress tracking system can automatically generate one or more simulated events based on the data associated with the current state. For example, a given state may indicate that a particular event is expected and is a requirement for the scenario to move to the next state. For example, if the current state is “waiting for passenger to enter autonomous vehicle,” the scenario progress tracking system can require an event that indicates that the passenger has entered the autonomous vehicle before moving to the next state in the scenario (e.g., travel to the destination location.)

In response, the scenario progress tracking system generates the one or more necessary events and transmits each generated event to the simulation system. The scenario progress tracking system can also monitor data (e.g., simulated events and the actions of the autonomous vehicle) to determine whether the simulation has met one or more conditions to move to another state of the predefined scenario. Thus, if the scenario progress tracking system determines, based on data for the current state, that the requirements for transitioning to a next state have been met, the scenario progress tracking system can access information from the scenario state queue data structure and transition the simulation to another state. In some examples, the scenario data store includes data associated with the scenario simulation including the current state, any current transition requirements, and data that can be used to replay the currently simulated scenario. Thus, when a scenario is transitioned from a first state to a second state the data stored in the scenario data store representing the current state and any current requirements can be updated.

A predefined scenario can include data representing a specific service assignment. As noted above, a rider transport scenario can include data describing a plurality of states necessary to successfully deliver a rider a specified destination including, but not limited to receiving a transportation request from a user, navigating to a user's pick-up point, picking up that user, navigating to the user's designated destination, and dropping off the user within an expected amount of time. A predefined scenario that represents this service assignment can include data representing each state of the process. In some examples, each state may be referred to as a step of the scenario. Each predefined scenario can also include one or more expected events associated with each state in the scenario. In the above example, after the autonomous vehicle has navigated to a user's pick-up point, the predefined scenario data can include the expected event of the user entering the autonomous vehicle. In some examples, if an expected event fails to occur, the scenario progress tracking system can transition the simulation into a failure state and end the simulation of the predefined scenario.

In some examples, a predefined scenario can be represented as a directed state graph. A directed state graph includes a plurality of nodes and edges between those nodes. Each edge has a given direction, such that the graph moves from one node, across an edge, to another node, but cannot return. In this example, each node in a directed state graph associated with a predefined scenario can represent a state in that predefined scenario. For example, a directed state graph for “giving a passenger a ride to a destination” can include a series of possible states including, but not limited to: waiting for a ride request, traveling to a designated pickup zone, waiting for a passenger to enter the autonomous vehicle, traveling to a designated destination zone, and waiting for the passenger to exit car. Each node (e.g., a state in the predefined scenario) can be connected to one or more other nodes by edges. Each of the edges represents a set of preconditions that must be met to move from the first node to the second node. In some examples, a precondition can include one or more events that are expected to occur.

In some examples, a simulation of a predefined scenario can be initiated in an initial state of the predefined scenario (e.g., the first node in the directed graph). In some examples, a user can customize a predefined scenario by designating an initial position or one or more initial parameters. Once the simulation of the predefined scenario has been initiated into an initial state, one or more events can be received. For example, if the initial state is waiting for a ride request, the simulation can generate a ride request automatically or a user can supply a ride request. Once an event has been received, the scenario progress tracking system can determine whether to transition the simulation into another state based on whether one or more preconditions have been met. For example, receiving a ride request with a pickup location can be sufficient to meet the preconditions for transitioning to the “navigate to a pickup zone” state.

When an event is received the scenario simulation system can determine one or more event parameters received with the event. Event parameters can include event type, event status code, and generating an actor associated with the event. In some examples, certain events can only be generated by particular actors in the scenario. For example, a location update can only be generated by a simulated vehicle. If the actor who generated an event does not match the expected event, the event can be determined to be an unexpected event.

In some examples, an unexpected event can occur (e.g., the simulated passenger does not enter the autonomous vehicle). In response, the scenario progress tracking system can cause the simulation to enter a failure state. In some examples, any unexpected event can serve as the precondition to enter one or more failure states. In some examples, a failure state can also be a terminal state, meaning that the simulation of the predefined scenario ends when that state is reached. For example, if a simulated passenger fails to enter the autonomous vehicle, the simulation of the predefined scenario may end without continuing to any other state. In some examples, a failure state may not be terminal. For example, if the autonomous vehicle initially fails to reach the pick-up zone, the scenario progress tracking system can cause the simulation to enter a failure state such as “contact remote support for assistance” which allows for additional progress in the predefined scenario.

The scenario simulation system can continue to receive events and transition the simulation to new states until a terminal state is reached. In some examples, when a scenario is successfully completed the final state is a successful termination state. In some examples, each predefined scenario can include metadata that determines whether each state (e.g., each node in the state graph) is terminal. Once a simulation of a predefined scenario is reached, the scenario simulation system can record relevant simulation data in the scenario data store. This information can be analyzed to identify any potential problems with the performance of the autonomous vehicle during the simulated scenario.

In some examples, predefined scenarios are predefined by the simulation system (or a user associated therewith). In other examples, predefined scenarios can be received from one or more users and stored in the scenario repository. Thus, users can create and use their own predefined scenarios. In addition, users may supply one or more parameters to an existing predefined scenario to customize the predefined scenario. For example, the user can specify a particular pickup and drop off areas for a ride request.

For example, using an electronic device, a user can transmit a request to start a simulation to a communication interface associated with the scenario simulation system. In some examples, the communication interface is a vendor integration platform that provides access through API calls to the backend services of the service entity. When configuring a simulation, a third-party entity (e.g., a computing system associated therewith) can request a simulation environment, configure it with a set of actors (e.g., simulated user(s), simulated autonomous vehicle(s), simulated driver, etc.), run simulations, and deactivate the simulation environment after the simulation run is completed. In some implementations, an actor can be used only in one simulation environment at any given time to provide isolation between simulation runs. Simulation environments (e.g., sandboxes, etc.) can be used for capturing test logs, actor state changes (e.g., which can be replayed or reproduced), and/or other information. A simulation environment service can use an external database for persisting data (e.g., sandbox data, etc.) and actor registry. Such data can include, for example, static entries such as a registry of actors and their keys in other systems and information about which actors belong within which sandbox.

As described herein, the simulation environment (e.g., sandbox, etc.) can be configured to isolate the simulation from real-world service assignment allocation by the entity's infrastructure and can include the simulated actors (e.g., simulated user, simulated vehicle, etc.) to be utilized in the simulation. In some examples, the request to start a simulation can include one or more request parameters including, but not limited to, an identifier of the autonomous vehicle to be simulated in the simulation, a selection of a predefined scenario (or a submitted predefined scenario), one or more details about the simulated environment (e.g., type of environment, location, and so on), and any other relevant details to running the simulation. In some examples, the selection of a predefined scenario includes either a full description of all data necessary for a scenario simulation or a reference identifier number to access associated information in the scenario repository. The vendor integration platform passes the request to a scenario simulator associated with the simulation service.

In some examples, the scenario simulator can initiate a simulation by generating a simulated environment via an environment simulator and a simulated autonomous vehicle via an AV simulator. In some examples, the simulated autonomous vehicle can access one or more services of the one or more backend systems of the service entity during the simulation. In addition, the simulation system can also engage the scenario simulation system to initiate simulation of the selected scenario. In some examples, the scenario simulator can access data describing the selected predefined scenario from a scenario repository. The data describing the selected predefined scenario can include a directed state graph. This data can then be published into a scenario state queue structure. Once the scenario simulation is initiated a simulation identifier value is transmitted back to the requesting user.

In some examples, the directed state graph can include a series of nodes, each node representing a state of the simulation (e.g., a step in a multi-step scenario). The series of nodes can be entered in a scenario state queue data structure that can be accessed by the scenario progress tracking system. The series of nodes can be connected based on directional edges. The edges are directional because the simulation can only transition in one direction. Thus, if node 1 is connected to node 2 with a directional edge going from node 1 to node 2, the simulation can transition from a state associated with node 1 to a state associated with node 2 but not from a state associated with node 2 to a state associated with node 1.

Each edge can be associated with one or more transition requirements. A transition requirement can constrain the transition between two nodes based on one or more criteria. When the current state is represented by a node that is connected to one or more other nodes by one or more edges, the scenario progress tracking system can periodically determine whether the transition requirements for any edge connected to the current node have been met. This determination can be made on a fixed periodic schedule. In addition, this determination can be made after each received event. Similarly, some events can be produced based on a periodic schedule. For example, a simulated autonomous vehicle may upload a current location every 10 milliseconds. Other events can be generated asynchronously. Such events represent the actions of other actors in a simulation.

When the requirements for a particular state are met, the scenario progress tracking system can transition the stored state information from a first state to a second state. In some examples, the transitional requirements for an edge between two nodes can include the requirement that a particular event has been received. For example, if the current state (as stored in the scenario data store) for a given autonomous vehicle or scenario is “navigating to a drop off point,” one of the transition requirements to transition to a “wait for a passenger to exit the vehicle” state can include receiving a location event indicating that the autonomous vehicle has reached the drop off point. If this event has not been received, the scenario progress tracking system will not allow transition between the current state and the next state.

In some example embodiments, a predetermined scenario can include one or more expected events that are necessary for a predefined scenario to be completed. These events can be generated by the user through an event generating service installed on their local computing devices. In this way, a user can have direct control over what events are received and when they are received. In some examples, the scenario progress tracking system itself can generate events based on the scenario data received from the state queue data structure. Thus, if certain events are deemed necessary for a given scenario (or the user has indicated that the user will not generate the events) the scenario progress tracking system can automatically generate appropriate events and transmit the generated events to the simulation system.

In some examples, events are representative of the actions of a passenger, remote operator, or another user that interacts with the autonomous vehicle or environment during the course of the predefined event. For example, a passenger may generate a ride request. This event can be simulated without having an actual passenger generate a ride request. In some examples, a scenario simulation system can receive events from one or more actors (e.g., users who interact with the service entity during a task). In this case, events can be generated by more than one source. For example, events generated by a passenger can be generated in response to input by a user and events associated with a remote operator can be generated by the scenario progress tracking system.

In some examples, the data describing a respective state can include one or more expected events. In response to determining that a received event was not expected, the scenario progress tracking system can transition into a failure state. In some examples, some expected events can include a temporal factor, such that if the event is not received during a predetermined time frame, the scenario progress tracking system can transition to a failure state. In some examples, a given node in a directed graph includes an edge that transitions back to the same node. In this way, if an event is received that does not materially change the current situation (e.g., a location update from the simulated autonomous vehicle) the current state does not need to be changed.

Whenever the scenario progress tracking system updates the current state after a transition, it can determine whether the new state is a terminal state for the directed graph. In some examples, the scenario progress tracking system can determine whether a given state is a terminal state based on metadata associated with the directed graph which includes a flag for each node. The flag associated with each node can denote whether the node is terminal or not.

In addition, when the scenario progress tracking system transitions from a first state to a second state, the scenario progress tracking system can update the scenario state data to reflect the new state. For example, a state indicator value can be updated to represent the current state. In addition, the scenario progress tracking system can update a list of transition requirements and the associated next state. As such, the scenario progress tracking system can update the current transition requirements such that the scenario progress tracking system can accurately track the current state and any associated transition requirements.

The scenario progress tracking system continues to monitor the simulation, transition between states as transition requirements are met, and generate events as necessary until a terminal state is reached. If all the expected events are received and correctly responded to, the simulation will reach a final state of the predefined scenario, which is a successful terminal state. When the simulation reaches a terminal state (successful or not), the scenario progress tracking system can record simulation data in the scenario state data. This data can be analyzed later to determine whether any unforeseen errors occurred. Once a terminal state has been reached, simulation of the selected predefined scenario can be completed.

In some examples, the selected predefined scenario is the “Happy Trip” scenario which represents a ride request scenario. In this example, once the simulated environment and the simulated autonomous vehicle have been generated, the first state is a hold state in which the autonomous vehicle is not active. The simulated vehicle can, when ready to begin, transmit a “vehicle ready” event to the service system, via an API interface. As a result, the scenario progress tracking system can transition into a second state, the “vehicle ready” state. While in that state, the vehicle can transmit an open itinerary event, which causes the scenario progress tracking system to transition into a “waiting for request” state.

In some examples, a simulated rider request event can be generated by an actor at the simulation system or at a computing device associated with the user. The scenario progress tracking system can transition into a vehicle response state. In this state, the vehicle can accept the ride request or reject the ride request. In some examples, if the vehicle rejects the ride request, the scenario progress tracking system can transition into a failure state. Similarly, the autonomous vehicle can be expected to upload location updates at a reliable rate. If the time between location updates exceeds a predetermined limit, the scenario progress tracking system can transition to a failure state.

If the autonomous vehicle accepts the rider request, the scenario progress tracking system transition to a “perform ride state.” During this ride, if the autonomous vehicle or passenger cancel the ride for any reason, the scenario progress tracking system can transition to a failure state. If not, the scenario progress tracking system can receive a ride completed event (or determine that the vehicle has arrived at the destination location) and transition into a “ride complete” state. The scenario progress tracking system can then transition into the successful terminal state and end the simulation of the “Happy Trip” scenario.

The systems and methods described herein provide a number of technical effects and benefits. More particularly, the systems and methods of the present disclosure provide improved techniques for evaluating the ability of an autonomous vehicle (e.g., of a third-party vehicle fleet) to integrate and communicate with the infrastructure of a service entity while performing complicated tasks over a long period of time. For instance, the scenario simulation system (and its associated processes) allow the service entity and/or a third-party entity (e.g., vehicle vendor) to create test actors such as simulated autonomous vehicles and simulated user accounts and to select predefined multi-step scenarios and match them with a simulated autonomous vehicle. The scenario simulation system provides a third-party entity with an event generation system that simulates user (e.g., rider, etc.) behavior and verifies that the autonomous vehicles progress the selected scenario to the expected state. Moreover, the scenario simulation system allows for this type of simulation to occur in a simulation environment (e.g., sandbox, etc.) that is isolated from real-world service assignment production, allocation, and coordination. This leads to an improved integration with the service entity's infrastructure (and the public API platform) by making the integration process more straightforward and helping to build more confidence in the platform, without having to distribute a real-world production service assignment to the autonomous vehicle. As such, integration issues can be efficiently identified in an offline, isolated environment before deployment of the vehicles in the real-world.

Additionally, predefined scenarios can provide the technical effect and benefit of allowing reducing the need for developers to generate computer code for each particular simulation to run autonomous vehicle service simulations. The use of predefined scenarios provides for more efficient vehicle integration testing. This leads to reduced computational waste and reduces bandwidth requirements by providing a programmatic interface for operating simulations.

Various means can be configured to perform the methods and processes described herein. For example, a computing system can include tracking unit(s), data generation unit(s), data obtaining unit(s), operation determination unit(s), remote autonomous vehicle (AV) assistance unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain data indicative of an autonomous vehicle to be tested within a simulation associated with a service entity (e.g., tester account data, vehicle account data, vehicle autonomy capability data, etc.). The means can be configured to generate a simulation environment (e.g., sandbox) for the simulation. The means can be configured to obtain generate actors for the simulation. For example, the means can be configured to generate a simulated user, a simulated autonomous vehicle, and/or other actor(s) within the simulation environment. The means can be configured to identify a predefined scenario for the autonomous vehicle to be tested within the simulation. The means can be configured to generate a simulated autonomous vehicle within a simulation environment based at least in part on the data indicative of the autonomous vehicle and the predefined scenario. The means can be configured to initiate a simulation of the predefined scenario using the simulated autonomous vehicle to perform the predefined scenario within the simulation environment. The means can be configured to provide the simulated autonomous vehicle access to one or more services of the one or more backend systems of the service entity during the simulation. The means can be configured to receive one or more simulated events, the simulated events enabling the simulated autonomous vehicle to attempt to complete the predefined scenario. The means can be configured to determine, based on one or more criteria whether the autonomous vehicle has successfully completed the predefined scenario.

With reference to the figures, example embodiments of the present disclosure will be discussed in further detail.

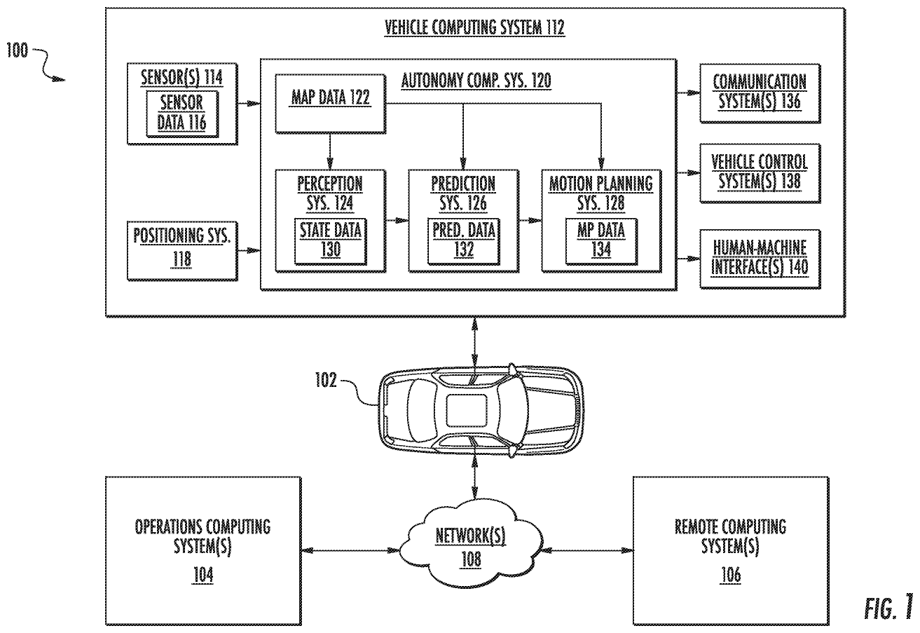

FIG. 1 depicts a block diagram of an example system 100 for controlling the navigation of a vehicle according to example embodiments of the present disclosure. As illustrated, FIG. 1 shows a system 100 that can include a vehicle 102; an operations computing system 104; one or more remote computing devices 106; a communication network 108; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider (e.g., service entity) that can provide one or more vehicle services to a plurality of users via a fleet of vehicles (e.g., service entity vehicles, third-party vehicles, etc.) that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of one or more vehicles (e.g., a fleet of vehicles), with the provision of vehicle services, and/or other operations as discussed herein.

For example, the operations computing system 104 can be configured to monitor and communicate with the vehicle 102 and/or its users to coordinate a vehicle service provided by the vehicle 102. To do so, the operations computing system 104 can manage a database that includes data including vehicle status data associated with the status of vehicles including the vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing devices 106 and/or the vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 102 including a location (e.g., latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, bike, scooter, other light electric vehicle, etc.), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, and/or the state of an environment to the operations computing system 104, which can store an indication, record, and/or other data indicative of the state of the one or more objects within a predefined distance of the vehicle 102 in one or more memory devices associated with the operations computing system 104 (e.g., remote from the vehicle). Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy system sensor data 116 associated with one or more objects that are proximate to the vehicle 102 (e.g., within range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy system sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The autonomy system sensor data 116 can be indicative of locations associated with the one or more objects within the surrounding environment of the vehicle 102 at one or more times. For example, autonomy system sensor data 116 can be indicative of one or more LIDAR point clouds associated with the one or more objects within the surrounding environment. The one or more autonomy system sensors 114 can provide the autonomy system sensor data 116 to the autonomy computing system 120.

In addition to the autonomy system sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy system sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy system sensor data 116 from the one or more autonomy system sensors 114, attempt to determine the state of the surrounding environment by performing various processing techniques on the autonomy system sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on autonomy system sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around a vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a passenger seat in the back of the vehicle).

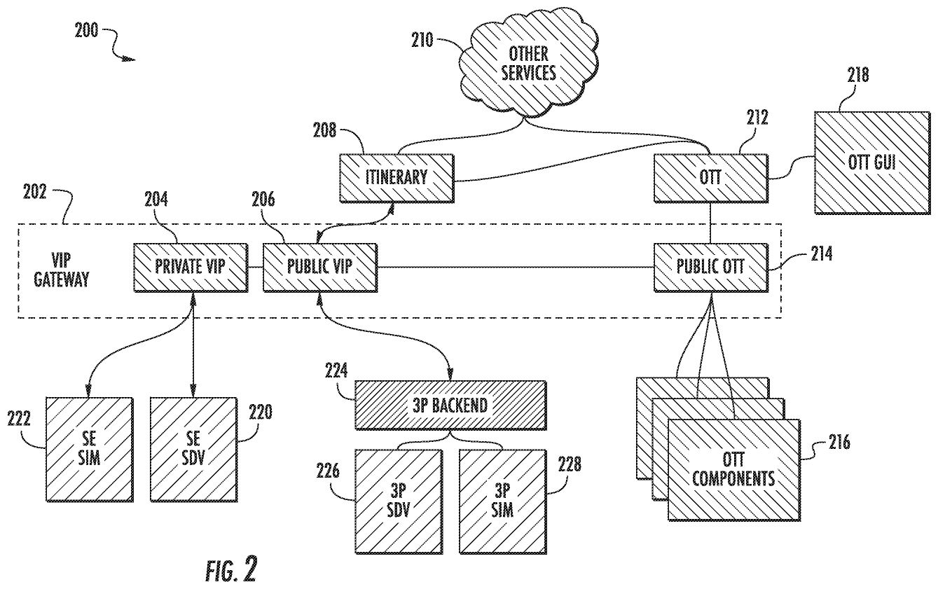

FIG. 2 depicts an example entity infrastructure 200 according to example embodiments of the present disclosure. A service entity (e.g., service provider, owner, manager, platform, and so on) can use one or more vehicles (e.g., ground-based vehicles, flight vehicles, etc.) to provide one or more vehicle services such as a transportation service (e.g., rideshare service), a courier service, a delivery service, and/or the like. For example, the service entity (e.g., via its operations computing system) can receive requests for vehicle services (e.g., from a user) and generate service assignments (e.g., indicative of the vehicle service type, origin location, destination location, and/or other parameters) for the vehicle(s) to perform. The vehicle(s) can be autonomous vehicles that include various systems and devices configured to control the operation of the vehicle.

The autonomous vehicles utilized by the service entity to provide the vehicle service can be associated with a fleet of that service entity or a third-party. For example, the service entity may own, lease, etc. a fleet of autonomous vehicles that can be managed by the service entity (e.g., by system clients associated with a service entity system) to provide one or more vehicle services. In some implementations, an autonomous vehicle can be associated with a third-party entity such as, for example, an individual, an original equipment manufacturer (OEM), or another entity (e.g., a “third-party autonomous vehicle”). Even though such an autonomous vehicle may not be included in the fleet of autonomous vehicles of the service entity, the platforms of the present disclosure can allow such a third-party autonomous vehicle to still be utilized to provide the vehicles services offered by the service entity, access its system clients, etc.

The service entity can provide an infrastructure 200 that can allow the service entity to assign the service assignment to an autonomous vehicle of the service entity's fleet, an autonomous vehicle of another entity's fleet (e.g., “a third-party autonomous vehicle”), and/or the like. Such an infrastructure 200 can include a platform (e.g., vendor integration platform (VIP)) comprising one or more application programming interfaces (APIs) that are configured to allow third-party autonomous vehicles (e.g., third-party AV 226) and provider infrastructure endpoints (e.g., system clients that provide backend services, etc. such as itinerary service 208, other services 210, etc.) to communicate. For example, a service entity infrastructure 200 can include an application programming interface platform (e.g., public VIP 206) which can facilitate communication between third-party autonomous vehicles and endpoints to help aid the delivery of a service assignment to the autonomous vehicle, monitor vehicle progress, provide remote assistance, etc. and, ultimately to support the performance of a service assignment by the third-party autonomous vehicles. The application programming interface (API) platform can have one or more functional calls defined to be accessed by a third-party autonomous vehicle (e.g., third-party AV 226) or a managing entity of third-party autonomous vehicles (e.g., third-party backend 224). In some examples, the API platform is a public API platform, such as shown by public VIP 206. The service entity can also provide third-party simulated autonomous vehicle (e.g., third-party sim 228) access to one or more services of one or more backend systems of the service entity during a simulation through the API platform, for example, via a testing system API such as public OTT 214. The service entity can also provide a service entity simulated autonomous vehicle (e.g., service entity sim 222) access to one or more services of one or more backend systems of the service entity during a simulation through the API platform.

The service entity infrastructure 200 can include a public API platform (e.g., public VIP 206) and a private API platform (e.g., private VIP 204) to facilitate services between the service entity infrastructure and autonomous vehicles (e.g., service entity autonomous vehicles 220, third-party autonomous vehicles 226). The public and/or private API platform can include one or more functional calls defined to be accessed by a third-party autonomous vehicle or a managing entity of third-part autonomous vehicles (and/or a service entity autonomous vehicle). For example, the public API platform (e.g., public VIP 206) can facilitate access to back-end services (e.g., provided by service entity backend system clients) by autonomous vehicles associated with one or more third-party vendors and/or the service entity's own fleet. The public VIP 206 can provide access to services such as service assignment services, routing services, supply positioning services, payment services, remote assist services, and/or the like. The private API platform (e.g., private VIP 204) can provide access (e.g., by service entity autonomous vehicles 220) to services that are specific to the service entity's autonomous vehicle fleet such as fleet management services, autonomy assistance services, and/or the like. Both the public VIP 206 and the private VIP 204 can include and/or be associated with a gateway API (e.g., VIP gateway 202) to facilitate communication from the autonomous vehicles to the service entity backend infrastructure services (e.g., backend system clients, etc.) and a vehicle API to facilitate communication from the service entity backend infrastructure services to the autonomous vehicles. Each of the platform's APIs can have separate responsibilities, monitoring, alerting, tracing, service level agreements (SLAs), and/or the like.

The service entity infrastructure 200 can include an OTT system 212 that can help verify that autonomous vehicles (e.g., entity autonomous vehicles, third-party autonomous vehicles, etc.) are able to fully utilize the backend services (e.g., system clients) of the service entity infrastructure 200 as well as to complete service assignments of the service entity. The OTT system 212 can be configured to simulate the end-to-end distribution, performance, and completion of a service assignment by an autonomous vehicle via the service entity infrastructure 200. For example, the OTT 212 system can create a simulated service assignment, assign the simulated service assignment to simulated autonomous vehicle (e.g., entity autonomous vehicle sim 222, third-party autonomous vehicle sim 228), and monitor the performance of the simulated autonomous vehicle. The simulated autonomous vehicle can be provided with access to the backend services of the service entity infrastructure 200 while completing the service assignment within a simulation environment. The service entity infrastructure 200 can include a testing system API, such as public OTT 214 to allow access to one or more services of one or more backend systems of the service entity via one or more OTT tools (e.g., OTT components 216) during a simulation through an API platform gateway (e.g., VIP gateway 202).

The OTT system 212 can include various sub-systems (e.g., OTT components 216, etc.) that allow the OTT system to run test simulations and present the results of the simulation. For instance, the OTT system can include a command line interface, a graphical user interface (e.g., OTT GUI 218), and an OTT library. The command line interface can be configured to manage test accounts (e.g., third party/vendor accounts, vehicle accounts, simulated user accounts, driver accounts, etc.). For example, the command line interface can be configured to create, delete, inspect, etc. data fields for test simulations/accounts to be utilized for simulation testing. The command line interface can also be configured to help facilitate the download of other tools, IDLs, libraries, etc. The OTT system 212 can also include a graphical user interface (e.g., OTT GUI 218) that allows a user to create simulated service assignments, visualize simulated service assignments, vehicles, and/or other information (e.g., logs, metrics, etc.), mock simulated user (e.g., rider, etc.) behavior, etc. The OTT system 212 can also include a library that allows for the programmatic performance of the functions of the command line interface and the graphical user interface. One or more of these sub-systems (e.g., OTT components 216) can be accessed outside of a network of the service entity, for example via public OTT 214.

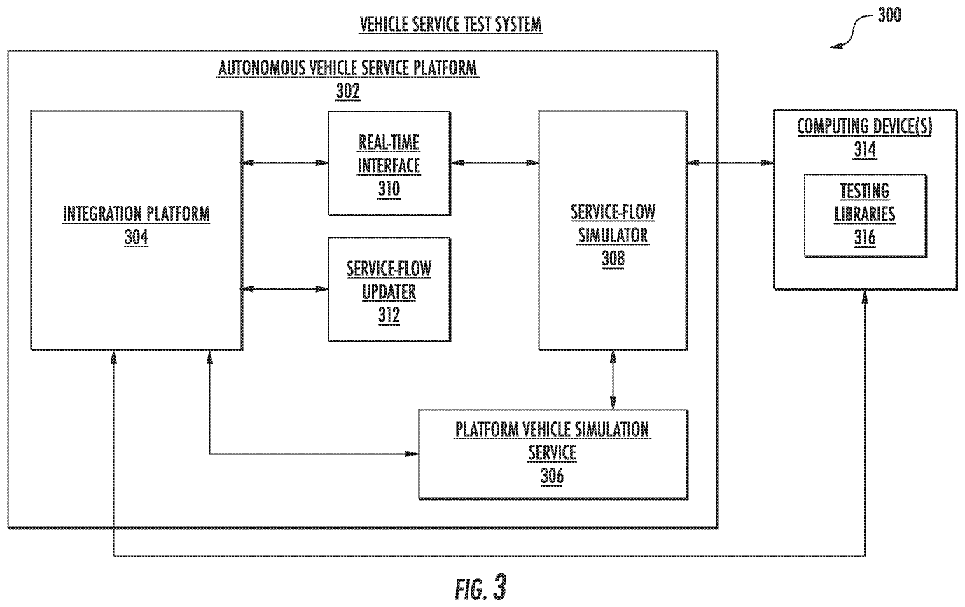

FIG. 3 depicts an example vehicle service test system 300 according to example embodiments of the present disclosure. A vehicle service test system, as illustrated in FIG. 3, can provide for evaluation of autonomous vehicle services through computer-implemented simulations of vehicle service-flows that utilize autonomous vehicles. A vehicle service test system 300 can include an autonomous vehicle service platform 302, an integration platform 304, a platform vehicle simulation service 306, a service-flow simulator 308, a real-time interface 310, a service-flow updater 312, one or more remote computing devices 314, one or more testing libraries 916, and/or the like.

A vehicle service test system 300 can provide one or more interfaces that enable users (e.g., software developers for autonomous vehicle computing systems, etc.) to design and test vehicle services using simulated autonomous vehicles. Data defining a simulated autonomous vehicle can be obtained in response to input received from a user through the one or more user interfaces. Similarly, data indicative of one or more parameters for at least one vehicle service simulation or scenario can be obtained, for example, in response to input received from a user through the one or more user interfaces. The test system may obtain from a remote computing system a request for an autonomous vehicle simulation. The test system can initiate one or more vehicle service simulations using the one or more parameters and the simulated autonomous vehicle. In this manner, users can define and debug vehicle service-flows within a single set of user interfaces. A user can manually control a vehicle service-flow in some examples by controlling an autonomous vehicle state. In other examples, a user can automate control of the vehicle service-flow using one or more predefined simulation scenarios. By providing a simulated testing environment that provides developer control over vehicle service-flows as well as autonomous vehicle definition, a quick and efficient technique for designing and evaluating vehicle service-flows can be provided.

The vehicle service test system 300 can be associated with an autonomous vehicle service platform 302. The autonomous vehicle service platform 302 can be associated with a service entity infrastructure which allows a service entity to provide vehicle services (e.g., transportation services (rideshare service), courier services, delivery services, etc.), for example, through vehicles in one or more vehicle fleets (e.g., service entity vehicle fleet, third-party vehicle fleet, etc.). For example, the autonomous vehicle service platform 302 can facilitate the generation of service assignments (e.g., indicative of the vehicle service type, origin location, destination location, and/or other parameters) to be performed by vehicles (e.g., within a fleet) in response to requests for vehicle services (e.g., from a user).

The autonomous vehicle service platform 302 can include integration platform 304 configured to integrate autonomous vehicles (e.g., autonomous computing systems) with the autonomous vehicle service platform 302. In some examples, the integration platform 3004 is configured to integrate autonomous vehicles from different systems, such as from different vendors or providers of autonomous vehicles. The integration platform 304 enables multiple third-party systems to be integrated into a single autonomous vehicle service platform 302. Additionally, the integration platform 304 enables autonomous vehicles directly controlled by the operator of the autonomous vehicle service platform 302 to be integrated into a common service with autonomous vehicles from third-party systems.

The vehicle service test system 300 can include one or more vehicle simulation services. A vehicle simulation service can include one or more instances of a simulated autonomous vehicle. For instance, a vehicle simulation service can be provided at the autonomous vehicle service platform 302 as a platform vehicle simulation service 306 in some examples. Additionally and/or alternatively, a vehicle simulation service can be implemented at a computing device (e.g., computing device 314, etc.) remote from the autonomous vehicle service platform as a local vehicle simulation service for example.

In some examples, a platform vehicle simulation service 306 can be implemented at the autonomous vehicle service platform 302, such as at the same set of servers and/or within the same network used to implement the autonomous vehicle service 302, for example. Such a platform vehicle simulation service 306 can include one or more instances of a simulated autonomous vehicle. Each instance of the simulated autonomous vehicle can include an interface associated with the integration platform 304. A developer can provide data in association with the instance of the autonomous vehicle and data in association with the vehicle service simulation through the same interface. For example, a developer can access an interface for the simulator to initialize and/or modify a state of the simulated autonomous vehicle instance.

Additionally, the same interface may be used to dispatch, accept, and simulate a vehicle service using the autonomous vehicle instance. In this manner, a developer can use a graphical user interface such as a browser interface rather than a command line interface for controlling an autonomous vehicle instance. The simulator may include a vehicle simulation service client configured to communicate with the platform vehicle simulation service 306. For example, the vehicle simulation service client can communicate with the platform vehicle simulation service 306 to accept vehicle service requests and control the autonomous vehicle instance. A developer can also use the graphical user interface to create a specific scenario, including a plurality of specific steps for an autonomous vehicle to perform a service. The state of the autonomous vehicle instance can be stored and updated in the simulator interface, and pushed to the platform vehicle simulation service 306. The platform vehicle simulation service 306 can be stateful and can route calls to the autonomous vehicle instance where the requested autonomous vehicle interface is running.

In some examples, a vehicle simulation service (e.g., platform vehicle simulation service 306) process may communicate with the integration platform 304 and simulation interfaces such as a service-flow simulator interface and/or vehicle simulator interface. In some examples, interfaces may be provided at one or more client computing devices (e.g., computing device 314, etc.). The vehicle simulation service process may include one or more endpoints (e.g., RPC endpoints) to facilitate communication with simulation interfaces (e.g., client computing devices using CLI and/or RPC).

The autonomous vehicle service platform 302 can include a service-flow simulator 308 configured as a tool for simulating service-flows using an autonomous vehicle. The vehicle service test system 300 can obtain data indicative of one or more parameters for at least one vehicle service simulation. The parameters for a vehicle service simulation may include parameters that define a vehicle service-flow. For example, data defining a vehicle service-flow may define a dispatch of a vehicle service to an instance of a simulated autonomous vehicle. Data defining the vehicle service-flow may also include data instructing the instance of the simulated autonomous vehicle to accept or reject the service request. The data may additionally include data indicative of service-flow updates and/or location updates. The data may indicate a route from a pick-up location to a drop-off location in example embodiments.

The autonomous vehicle service platform 302 can include a real-time interface 310 provided between the integration platform 304 and the service-flow simulator 308. A service request can be provided from the service-flow simulator 308 through the real-time interface 310 to the integration platform 304.

The autonomous vehicle service platform 302 can include a service-flow updater 312 that passes service-flow updates to and from the integration platform 304. Service-flow updates can be received at the integration platform 304 as a push notification from the service-flow updater 312. An update can be passed to the instance of the simulated autonomous vehicle corresponding to the service request. For example, an interface (e.g., SDK) inside the autonomous vehicle instance can establish a consistent connection (e.g., HTTP2) with the integration platform 304. A service request can be matched with the instance of the autonomous vehicle using a flag or other suitable identifier.

The vehicle service test system 300 can include one or more testing libraries 316 that can interface with the vehicle service test system 300 to provide for programmatically developing testing scenarios for running autonomous vehicle service simulations. For example, a developer can incorporate one or more testing libraries (e.g., a testing library 316) into code to programmatically control a test autonomous vehicle and/or vehicle service.

A testing library 316 can be used to interface with one or more simulation services and/or interface directly with an integration platform (e.g., integration platform 304). For example, one or more testing libraries (e.g., a testing library 316) may be used to interface with the autonomous vehicle service platform 302. In some examples, the vehicle service test system 300 may obtain data indicative of one or more parameters for at least one vehicle service simulation using one or more testing libraries (e.g., testing library 316). In some examples, service requests can be programmatically simulated via one or more testing libraries (e.g., testing library 316).

Instance(s) of a simulated autonomous vehicle can be deployed as a network service in some examples, such as at one or more servers in direct communication with the vehicle service test system 300. In other examples, the instances of the simulated autonomous vehicle can be deployed at a local computing device (e.g., computing device 314) remote from the vehicle service test system 300. The local computing device can be operated by the same entity that operates an autonomous vehicle service platform, or by a third-party entity. In either case, the vehicle service test system can communicate with the simulated autonomous vehicle instances using various communication protocols. In some examples, each instance of a simulated autonomous vehicle may include an interface such as an interface programmed in a software development kit (SDK) that is similar to or the same as an interface (e.g., SDK) included within an actual autonomous vehicle used to provide the vehicle service. The interface may enable the vehicle service test system to issue instructions to the autonomous vehicle instance to accept a service request, reject a service request, update the pose field of the autonomous vehicle instance, etc. In some examples, a user may deploy instances of a simulated autonomous vehicle using one or more test libraries (e.g., testing library 316).

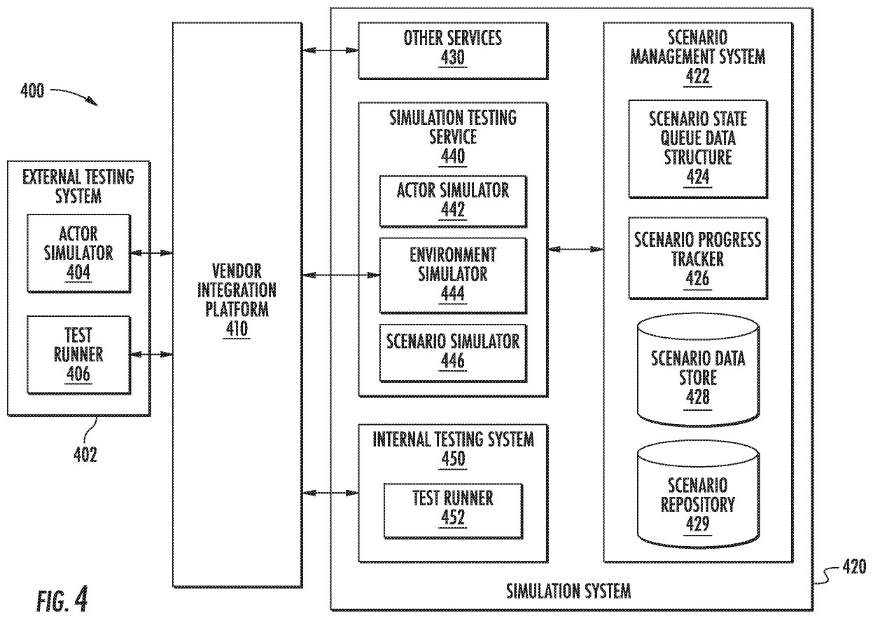

FIG. 4 depicts an example entity infrastructure according to example embodiments of the present disclosure. The entity infrastructure includes an external testing system 402, a vendor integration platform 410, and a simulation system 420. In some examples, the vendor integration platform 410 can be integrated into the simulation system 420. In other examples, the vendor integration platform 410 can be distinct from the simulation system 420 and will thus communicate to the simulation system 420 via a communication network. The external testing system 402 can be a computing system associated with a third-party entity and can communicate with the vendor integration platform 410 via a communication network.

The external testing system 402 can include an actor simulator 404 and a test runner 406. The external testing system 402 can transmit one or more API calls (e.g., requests to perform an action at the simulation system 420 via an API available to the external testing system 402). The external testing system 402 can communicate any API calls to the vendor integration platform 410 which is a public-facing interface that allows external systems (3^{rd} party systems that are authorized) to submit requests and receive the results from the simulation system 420.

Specifically, the test runner 406 can send and receive data associated with a simulation to the simulation system 420 via the vendor integration platform 410. The test runner 406 can, in response to user input, transmit a request to initiate a simulation at the simulation system 420. In some examples, the test runner 406 can submit information associated with initiating a simulation, including, but not limited to, a selected scenario, information describing the autonomous vehicle to be tested, data associated with the simulation (e.g., the simulated location), and so on.

The actor simulator 404 can allow a user to interact with the simulation to generate events or simulate an actor within the simulation. For example, a user associated with a third party can, as part of a scenario, direct the simulation system 420 to generate particular events, generate actions for one or more actors, and so on. The actor simulator 404 can also provide information to simulate an autonomous vehicle. Thus, the autonomous vehicle can partially or wholly be simulated at the external testing system 402 and interact with the simulation system 420 via the vendor integration platform 410.

The vendor integration platform 410 can be a self-driving platform gateway that receives communication from all autonomous vehicles that provide services for the service entity. The vendor integration platform 410 can include provide APIs that allow external systems to submit requests to, and receive responses from, the simulation system 420. In some examples, the vendor integration platform 410 validates requests before passing the requests to the simulation system 420 to ensure that all requests meet the requirements of the simulation system.

The simulation system 420 includes a simulation testing service 440, an internal testing system 450, and an other services system 430 for providing miscellaneous other services, and a scenario simulation system 422. The internal testing system 450 includes a test runner 452 that is used for initiating, controlling, monitoring, and analyzing the results of a simulation run by the simulation system 420. Internal testers (e.g., users associated with the service entity) do not need to send requests to the vendor integration platform 410. Instead, internal testers can use the test runner 452 to request that a simulation be initiated directly by interacting with the simulation testing service 440. The test runner 452 also allows testers to identify the specific autonomous vehicle that is to be simulated and provide parameters for the simulation, including but not limited to the location of the simulation, the number of simulated actors and their characteristics, a specific predefined scenario to be tested, and any specific events or variables to be generated.

While a simulation is being performed, a user can use the test runner 452 to monitor the simulation, provide input needed for specific events, and make on-the-fly alterations to the simulation or scenario as needed. The simulation system 420 can provide, as needed, to the internal testing system 450 data representing the current state of the simulation (e.g., text, audio, or video) for a tester to view.

The simulation testing service 440 can include an actor simulator 442, an environment simulator 444, and a scenario simulator 446. The actor simulator 442 can simulate one or more actors within the simulation. For example, if a rider is needed to simulate a particular scenario, the actor simulator 442 can programmatically generate events as needed based on predefined scenario data. For example, if the predefined scenario data includes a rider submitting a ride request, the actor simulator 442 can automatically generate that event or cause the event to be generated at a time dictated by the predefined scenario.

In other examples, the actor simulator 442 can include an API that allows users (either external users from the external testing system 402 or internal users from the internal testing system 450) to request specific events to be generated for the simulation. For example, a user can specify that a specific event (e.g., successful drop-off of a rider) be generated at a particular time to test how the simulated autonomous vehicle will respond. In this way, a user can fully control and/or customize the specific situations that are tested by the simulation system 420.

An environment simulator 444 can generate a simulated sandbox in which the simulated autonomous vehicle is tested. The simulation sandbox can include a location that is being simulated, one or more other simulated entities within the sandbox (e.g., pedestrians, other vehicles, and so on), and static parts of the simulated environment (e.g., buildings, roads, signs, and so on). The environment simulator 444 can simulate an autonomous vehicle moving through that environment including simulating any needed physics, the actions of at least some other users, and so on. Thus, the sandbox can simulate the experience of an autonomous vehicle moving through an actual live environment.

A scenario simulator 446 can simulate one or more states of a selected predefined scenario. Specifically, the scenario simulator can receive scenario data from the scenario state queue data structure 424. The scenario data can include data describing a series of states associated with completing the scenario and a set of events associated with each state. The scenario simulator 446 can ensure that any events that are required to be generated by the simulation system (e.g., simulating riders or other actors in the environment) are generated in a timely manner. Similarly, the scenario simulator 446 can monitor the simulated autonomous vehicle to ensure that the simulated autonomous vehicle is generating the correct events at the correct times. For example, once a simulated autonomous vehicle receives a rider request, the simulated autonomous vehicle can be expected to generate a request acceptance action and then begin navigating to the pick-up point. The scenario simulator 446 can, in response to determining that the expected events have been generated and/or received, move the scenario from a first state or step to a second state or step. The scenario simulator can continue to monitor the scenario until the scenario reaches an end state (e.g., either a failure state or a completion state). The other services system 430 can provide series of other services required by the simulation system, such as an internal actor simulator that serves to generate events for simulated riders and other actors in the environment.

A scenario simulation system 422 can include a scenario state queue data structure 424, a scenario progress tracking system 426, a scenario data store 428, and a scenario repository 429. In some examples, the scenario repository 429 stores data associated with a plurality of predefined scenarios that be selected to simulate a task associated with the predefined scenario. When a simulation begins, the simulation system 420 can receive, in a request from a user, a selection of a specific predefined scenario. The scenario simulation system 422 can access data associated with the selected predefined scenario from the scenario repository 429 and load it into the scenario state queue data structure 424. In some examples, the scenario state queue data structure 424 is a queue data structure (e.g., a first-in-first-out queue) that is populated with data representing a list of states associated with completing a selected scenario. The scenario progress tracking system 426 can access data for a first state in a multi-state process, transmit accessed data to a simulation system 420 (or more specifically, the scenario simulator 446), and track the current state of the scenario simulation. In some examples, the scenario progress tracking system 426 can, working in concert with the scenario simulator 446, automatically generate one or more simulated events based on the data associated with the current state. For example, the data associated with a given state may indicate that a particular event is expected and is a requirement for the scenario to move to the next state. If the current state is “waiting for the passenger to enter the autonomous vehicle,” the scenario progress tracking system 426 can require an event that indicates that the passenger has entered the autonomous vehicle before moving to the next state in the scenario (e.g., travelling to the destination location.)

In response, the scenario progress tracking system 426 generates the one or more necessary events and transmits each generated event to the simulation system 420. The scenario progress tracking system 426 can also monitor data (e.g., simulated events and the actions of the autonomous vehicle) to determine whether the simulation has met one or more conditions required to move to another state of the predefined scenario. Thus, if the scenario progress tracking system 426 determines, based on data for the current state, that the requirements for transitioning to a next state have been met, the scenario progress tracking system 426 can access information from the scenario state queue data structure 424 and transition the simulation to another state. In some examples, the scenario data store 428 includes data associated with the scenario simulation including the current state, any current transition requirements, and data that can be used to replay the currently simulated scenario. Thus, when a scenario is transitioned from a first state to a second state the data stored in the scenario data store representing the current state and any current requirements can be updated based on data retrieved from the scenario state queue data structure 424.

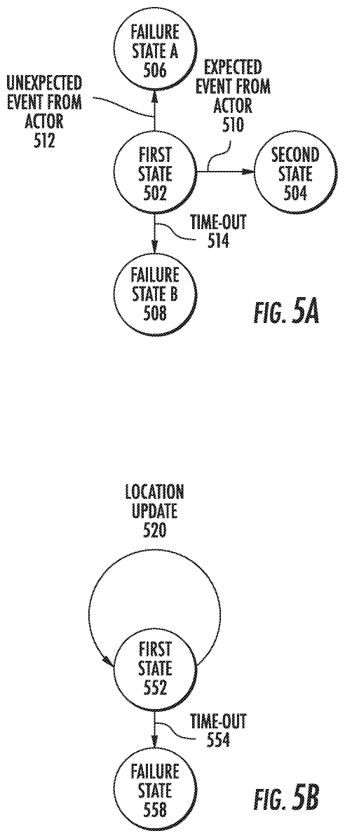

FIG. 5A depicts a state machine diagram according to example embodiments of the present disclosure. In this example, the scenario or simulation is in a first state 502. Note that this may not be the initial state of a multi-state directed graph. While in the first state 502, a component of the simulation system (e.g., simulation system 420 of FIG. 4) can monitor the simulation for events. If an expected event 512 is received from an actor (e.g., a simulated autonomous vehicle), the scenario can move from the first state 502 to a second state 504 along a directed edge.

If an unexpected event is received from the actor (e.g., the simulated autonomous vehicle unexpectedly drives to the wrong address or turns down a ride offer that it should have accepted), the scenario can move from the first state 502 to a failure state (in this case failure state A 506). In some examples, moving into a failure state requires intervention from a simulated actor or input from the user directing the simulation. In other examples, moving into a failure state can cause the simulation of the predefined scenario to end. Once the predefined scenario has ended, the simulation system can store or transmit data describing the simulation such that further analysis can be performed.

In some examples, a time limit can be associated with a particular state. Thus, if no event is received within the time limit, the system determines that the actor (e.g., the simulated autonomous vehicle) has timed-out and the scenario enters a failure state (in this case failure state B 508). The failure states can be distinct so that the specific reason for entering a failure state can be quickly and easily determined by a reviewing user.

FIG. 5B depicts a state machine diagram according to example embodiments of the present disclosure. In this example, the scenario is in a first state 552. The first state 552 can be a state in which the autonomous vehicle provides a series of location updates 520 (e.g., while waiting for a rider request or traveling to a destination). The simulation system (e.g., simulation system 420 of FIG. 4) can maintain the scenario in the first state 552 by continuously returning the scenario to the first state 552 each time a location update 520 is received. However, if an expected location update 520 is not received from the simulated autonomous vehicle within a predefined amount of time, the simulated autonomous vehicle (or other simulated actor that is being tested) is determined to have timed out 552 and the scenario is moved into a failure state 558.

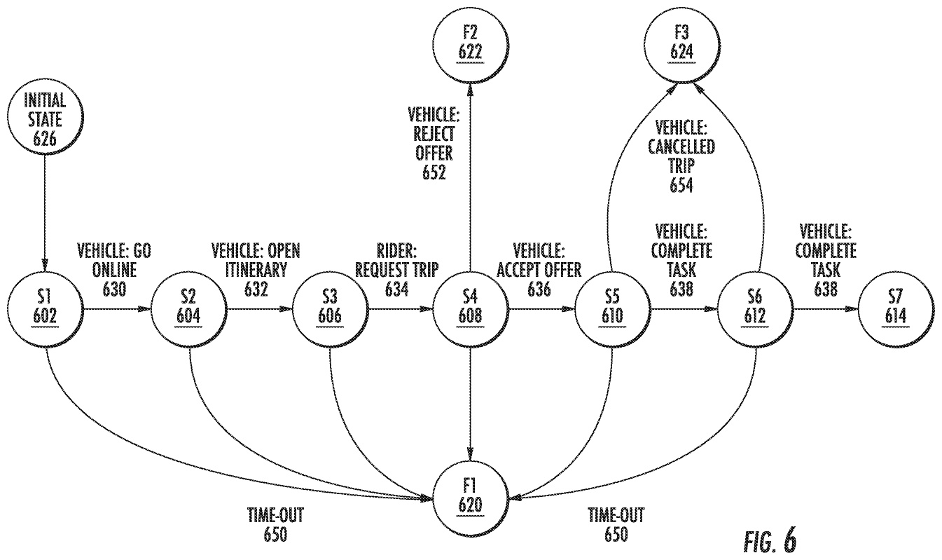

FIG. 6 depicts a state machine flow diagram according to example embodiments of the present disclosure. In this example, the state machine flow diagram represents a directed graph for the “rider request” predefined scenario. As noted above, the directed graph is a series of nodes connected by edges. Each node represents a state in the predefined scenario and each edge represents a particular event that causes the state machine to move from one state to another.

The initial state 626 represents the initial state of the predefined scenario when it begins. The scenario simulation system (e.g., scenario simulation system 422 in FIG. 4) automatically moves to S1 602, the first state in the rider request predefined scenario. Each state can include a time limit that represents an amount of time before the scenario simulation system determines that the simulated autonomous vehicle has timed out 650 and enters the F1 failure state 620. The specific time limit can vary based on the current state and the simulated autonomous vehicle.

While in the S1 state 630, the scenario simulation system can monitor for events generated by the simulated autonomous vehicle. Once the simulated autonomous vehicle has performed any preparation tasks, the simulated autonomous vehicle generates a “go online” event 630. In response, the scenario simulation system can move the scenario from the S1 state 602 to the S2 state 604. The simulated autonomous vehicle can generate an “open itinerary” event 632 once the simulated autonomous vehicle is prepared to receive rider requests.

The scenario simulation system can, in response to receiving the “open itinerary” event 632, move the scenario from the S2 state 604 to the S3 state 606. Once the scenario has reached the S3 state 606, the scenario simulation system can cause a simulated rider to generate a request trip event 634. The user can designate one or more trip characteristics including the origin location and destination location.

Once the request trip event 634 has been generated, the scenario simulation system can move the scenario from the S3 state 606 to the S4 state 604. In response to a request trip offer 634, a simulated autonomous vehicle can either accept the offered trip or reject the offered trip. If the simulated autonomous vehicle generates a “reject offer” event 652, the scenario can move into the F2 failure state 622. The F2 failure state 622 indicates that the simulated autonomous vehicle has unexpectedly rejected an offered trip. The scenario can then be terminated.

If the simulated autonomous vehicle generates an accept offer event 636, the scenario simulation system can move the scenario from the S4 state 608 to the S5 state 610. Once the simulated autonomous vehicle completes the rider request (e.g., by picking up the simulated rider and delivering the simulated rider to a destination location), the simulated autonomous vehicle can generate a “complete task” event 638. However, if the simulated autonomous vehicle is unable to complete the rider request for any reason, the simulated autonomous vehicle can generate a “canceled trip” event 654. In response, the scenario simulation system can move the scenario into failure state F3 (624) and end simulation of the scenario.

Once the “complete task” event 638 is generated, the scenario simulation system can move the scenario from the S5 state 610 to the S6 state 612. The autonomous vehicle can generate a complete scenario event 640, once the rider request scenario is successfully completed. In response, the scenario simulation system can change the state to completion state S7 614.

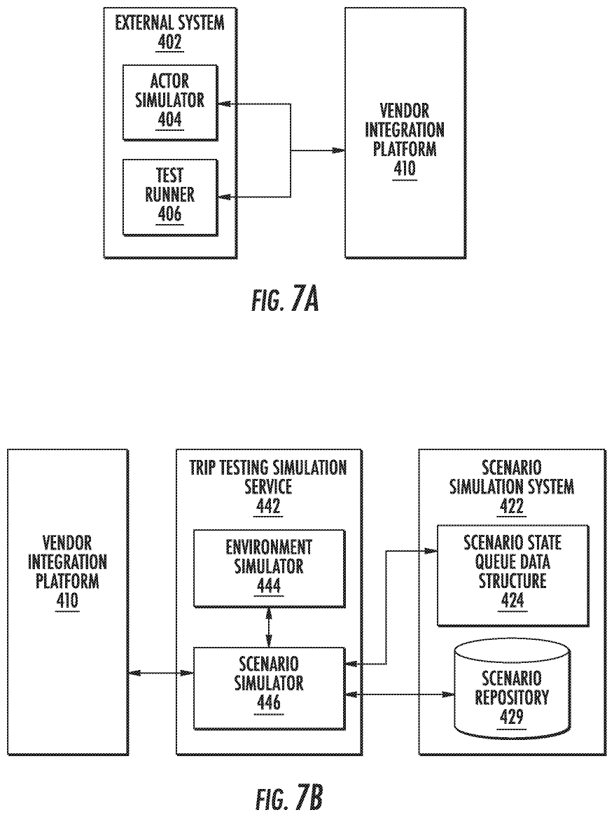

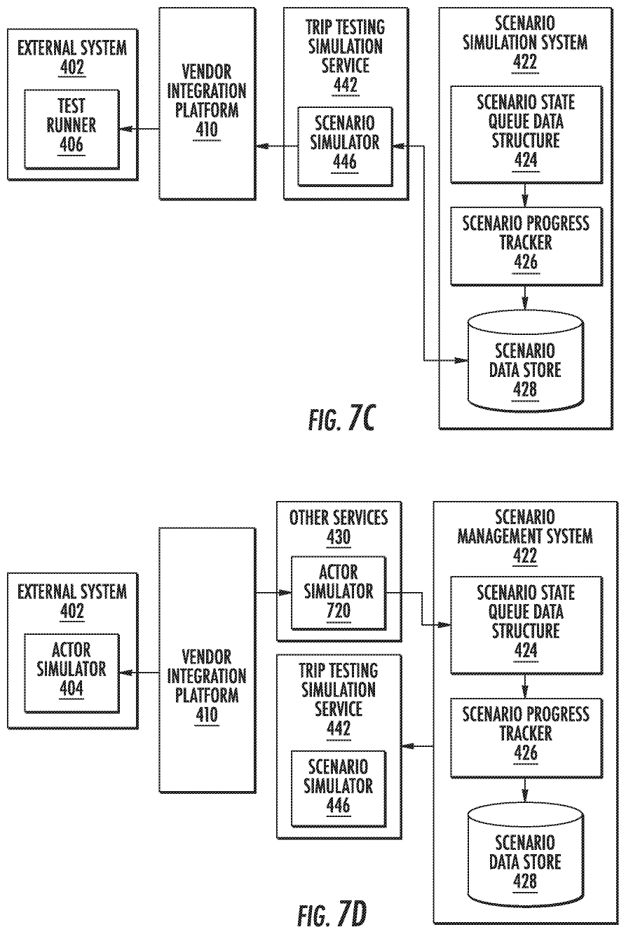

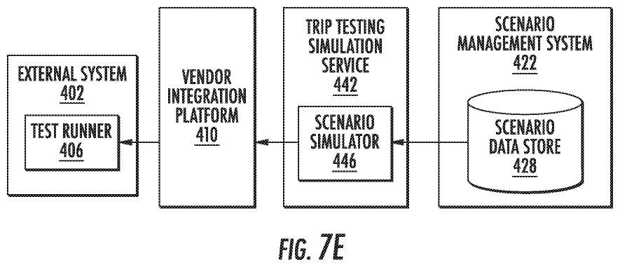

FIG. 7A depicts an example data flow diagram according to example embodiments of the present disclosure. In this example, the test runner 406 can initiate a simulation via a communication request to the vendor integration platform 410. The communication request can include an indication of a particular predetermined scenario. The actor simulator 404 can manage the simulation of one or more simulated actors in the simulation including, but not limited to the simulated autonomous vehicle. The vendor integration platform 410 can pass requests on to the simulation system 420.

FIG. 7B depicts an example data flow diagram according to example embodiments of the present disclosure. The vendor integration platform 410 can validate any requests it receives from an external system. For example, the vendor integration platform 410 can validate scenario graphs, valid parameters, and check that all the actors referenced with the request are included within the same simulation sandbox. The vendor integration platform 410 can pass the request on to the simulation testing service 440 once it is validated.

The scenario simulator 446 can access the environment simulator 444 to update the simulation such that the requests are reflected in the simulation environment itself. The scenario simulator 446 can access predefined scenario data from the scenario repository 429 based on the predefined scenario indicated by the simulation request. The scenario simulator 446 can then store the predefined scenario data in the scenario state queue data structure 424. Specifically, the scenario state queue data structure 424 can store data representing states in the scenario. The scenario simulation system 422 can initiate simulation of the scenario using the data stored in the scenario state queue data structure 424.

FIG. 7C depicts an example data flow diagram according to example embodiments of the present disclosure. The scenario progress tracker 426, using data accessed from the scenario state queue data structure 424, can initiate a scenario with a specific scenario state (e.g., the initial state). The current state of the scenario and any other parameters can be stored in the scenario data store 428. Once the scenario has been initiated, information associated with the specific simulation and scenario are transmitted back to the scenario simulator 446. The scenario simulator 446 can transmit scenario identification data to the vendor integration platform 410. The vendor integration platform 410 can then transmit the data to the test runner 406.

FIG. 7D depicts an example data flow diagram according to example embodiments of the present disclosure. While the scenario is running in the simulation, one of either actor simulator 720 in the internal other services system 430 or the actor simulator 404 in the external testing system 402 can generate events based on the data in the scenario state queue data structure 424. As the scenario runs, the scenario progress tracker 426 can update the state data in the scenario data store 428. Once the scenario has reached completion (e.g., the state has been updated to a final state or terminal state), the scenario can be marked as complete in the scenario data store 428.

FIG. 7E depicts an example data flow diagram. according to example embodiments of the present disclosure. The external testing system 402 can send a request to determine the current state of the scenario using an identifier for the specific scenario that is being tested. In response, the scenario simulation system 422 can transmit information indicating that the scenario has been completed based on information in the scenario data store 428. The information can be transmitted from the scenario simulator 446 to the vendor integration platform 410 and on to the test runner 406 at the external testing system 402.

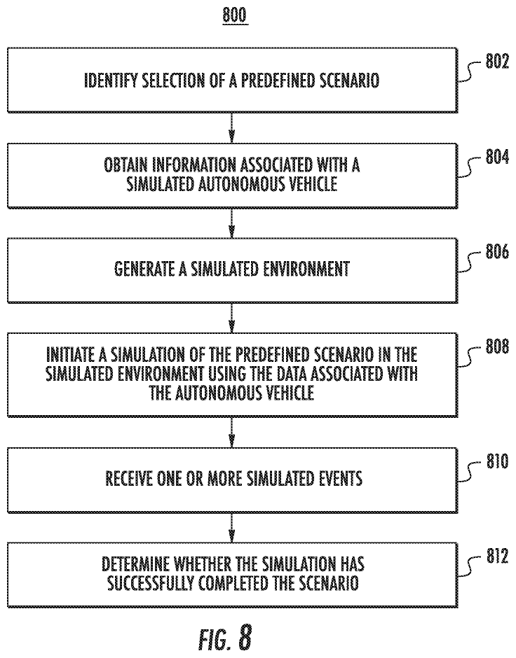

FIG. 8 depicts a flow diagram 800 of an example method for enabling the use of predefined scenario simulations according to example embodiments of the present disclosure. In some embodiments, a simulation system (e.g., simulation system 420 in FIG. 4) can obtain data indicative of an autonomous vehicle to be tested within a simulation associated with a service entity. The simulation system can identify, at 804, a predefined scenario for the autonomous vehicle to be tested within the simulation. The predefined scenario can be represented as a directed graph including a plurality of nodes connected by one or more edges.

In some example embodiments, the simulation system can obtain, at 804, data associated with a simulation of the autonomous vehicle to use within a simulation environment based at least in part on the predefined scenario. Thus, the actual simulation of the autonomous vehicle (e.g., what actions the autonomous vehicle takes and how it reacts to the events and actions from other simulated actors) can take place at a computing system remote from the simulation system (e.g., a third party computing system running a simulation of the autonomous vehicle) and the simulation can receive data representing the simulation of the autonomous vehicle. In other example embodiments, the simulation system can receive information describing the autonomous vehicle to be simulated and the actions of the autonomous vehicle, while the actual simulation takes place at the simulation system.

The predefined scenario can include a series of states, each state associated with one or more state requirements. In some examples, the state requirements can include preconditions that must be met before the state is considered successfully completed. The predefined scenario can be received from a third-party computing system prior to being identified for use in a simulation. In some example embodiments, in response to identifying the predefined scenario, the simulation system can access scenario data from a scenario repository.

The simulation system can generate, at 806, a simulation environment based at least in part on the data associated with the autonomous vehicle and the predefined scenario. The simulation system can, at 808, initiate a simulation of the predefined scenario using data associated with the simulated autonomous vehicle to perform the predefined scenario within the simulation environment. The simulation environment can be a sandbox that is configured to isolate the simulation from a real-world service assignment allocation by the service entity.

The simulation system can provide, at 810, the simulated autonomous vehicle access to one or more services of the one or more backend systems of the service entity during the simulation. The simulation system can receive, at 812, the simulated events enabling the simulated autonomous vehicle to attempt to complete the predefined scenario. Each node can represent a state in the predefined scenario and the one or more edges are associated with simulated events, such that receiving a simulated event causes the simulation of the predefined scenario to transition from a first state to a second state.

Each state can be associated with one or more expected events and each event has one or more associated event parameters. The simulation system can, in response to receiving an event, access event parameter data for the event. The simulation system can determine, based on the event parameter data, whether the received event is an expected event. In response to determining that the received event is an expected event, the simulation system transitions from the current state to a failure state. In some example embodiments, the simulated events can be received based on input from a user. In some example embodiments, the simulated events can be generated automatically by the computer system as part of the predefined scenario.

The simulation system can determine, at 814, based on one or more criteria whether the autonomous vehicle has successfully completed the selected predefined scenario. To make this determination, the simulation system can determine whether a second state is a terminal state. In response to determining that the second state is the terminal state, the simulation system can cease to perform simulation of the predefined scenario. The simulation system can determine whether the simulation has reached a terminal state. The simulation system can determine whether the autonomous vehicle has successfully completed the identified predefined scenario based on a representation of the terminal state. In response determining that the simulation has reached a terminal state, the simulation system can determine whether the terminal state is associated with successful completion of the predefined scenario.

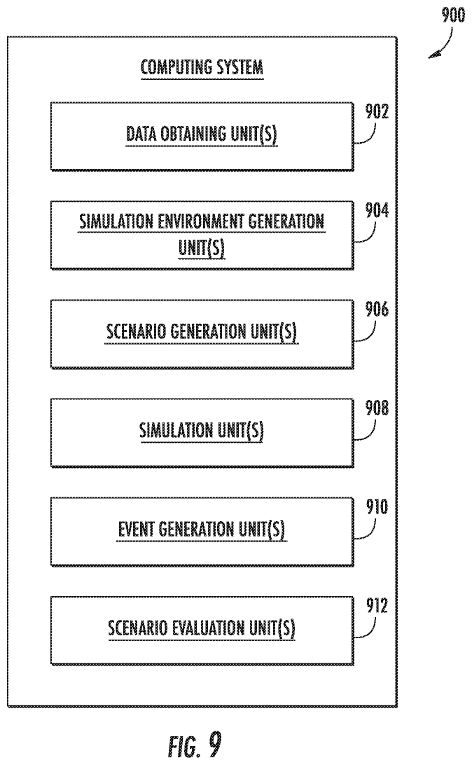

Various means can be configured to perform the methods and processes described herein. For example, FIG. 9 depicts a diagram of an example computing system that can include data obtaining unit(s) 902, simulation environment generation unit(s) 904, scenario generation unit(s) 906, simulation unit(s) 908, event generation unit(s) 920, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be configured to perform one or more algorithm(s) for carrying out the operations and functions described herein. For instance, the means can be configured to obtain data indicative of an autonomous vehicle to be tested within a simulation associated with a service entity and identify a predefined scenario for the autonomous vehicle to be tested within the simulation. For example, a simulation system can receive a request to initiate a simulation including a designated scenario to simulate. A data obtaining unit 912 is one example of a means for obtaining data indicative of an autonomous vehicle to be tested within a simulation associated with a service entity as described herein.

The means can be configured to generate, by the computing system, a simulated autonomous vehicle within a simulation environment based at least in part on the data indicative of the autonomous vehicle and the predefined scenario. For example, the simulation system can, using data obtained from a user, create a simulated autonomous vehicle and a simulated environment. A simulation environment generation unit 904 is one example of a means for generating a simulated autonomous vehicle and simulate an environment in which the simulated autonomous vehicle can be.

The means can be configured to initiate a simulation of the predefined scenario using the simulated autonomous vehicle to perform the predefined scenario within the simulation environment. For example, the system can begin entering a state associated with the predefined scenario. A scenario generation unit 906 is one example of a means for initiating a simulation of the predefined scenario using the simulated autonomous vehicle to perform the predefined scenario within the simulation environment.

The means can be configured to provide the simulated autonomous vehicle access to one or more services of the one or more backend systems of the service entity during the simulation. For example, the simulated autonomous vehicle can use the existing back-end services to receive requests, communicate with simulated users, and indicate its current status. A simulation unit 908 is one example of a means for providing, by the computing system, the simulated autonomous vehicle access to one or more services of the one or more backend systems of the service entity during the simulation.

The means can be configured to receive one or more simulated events enabling the autonomous vehicle to attempt to complete the predefined scenario. For example, the means can be configured to allow a simulation system to receive events generated by a simulated autonomous vehicle that represent the simulated autonomous vehicles current status in the simulated scenario. An event generation unit 910 is one example of a means for receiving one or more simulated events, the simulated events enabling the autonomous vehicle to attempt to complete the predefined scenario

The means can be configured to determine based on one or more criteria whether the autonomous vehicle has successfully completed the selected predefined scenario. For example, if the system determines that the scenario has reached an end state, the system can determine whether that end state is a success state or a failure state. A scenario evaluation unit 912 is one example of a means for determining based on one or more criteria whether the autonomous vehicle has successfully completed the selected predefined scenario.

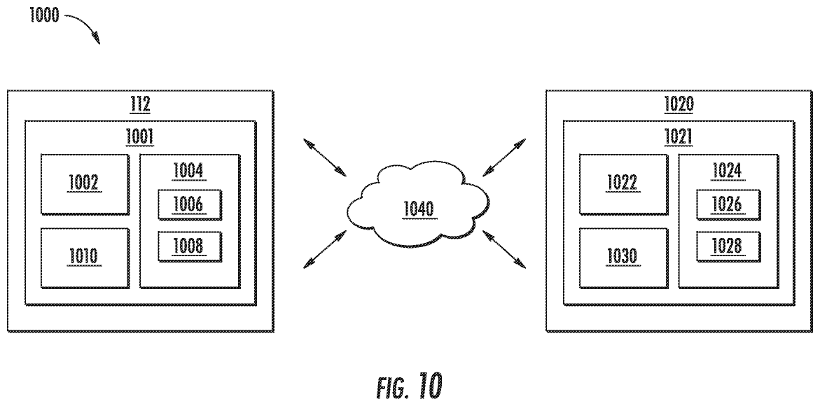

FIG. 10 depicts a block diagram of an example computing system 1000 according to example embodiments of the present disclosure. The example system 1000 illustrated in FIG. 10 is provided as an example only. The components, systems, connections, and/or other aspects illustrated in FIG. 10 are optional and are provided as examples of what is possible, but not required, to implement the present disclosure. As one example, the example system 1000 can include the vehicle computing system 112 of the autonomous vehicle 102 and a remote computing system 1020 (e.g., operations computing system, other computing system, etc. that is remote from the vehicle 102/vehicle computing system 112) that can be communicatively coupled to one another over one or more network(s) 1040. The remote computing system 1020 can be and/or include the operations computing system 104 and/or remote computing system 106 of FIG. 1, as an example. The remote computing system 1020 can be associated with a central operations system and/or an entity associated with the vehicle 102 such as, for example, a vehicle owner, vehicle manager, fleet operator, service provider, etc. For instance, the remote computing system 1020 can be or otherwise include the remote computing system 104 described herein.

The computing device(s) 1001 of the vehicle computing system 112 can include processor(s) 1002 and at least one memory 1004. The one or more processors 1002 can be any suitable processing device (e.g., a processor core, a microprocessor, an ASIC, a FPGA, a controller, a microcontroller, etc.) and can be one processor or a plurality of processors that are operatively connected. The memory 1004 can include one or more non-transitory computer-readable storage media, such as RAM, ROM, EEPROM, EPROM, one or more memory devices, flash memory devices, magnetic disks, data registers, etc., and combinations thereof.

The memory 1004 can store information that can be accessed by the one or more processors 1002. For instance, the memory 1004 (e.g., one or more non-transitory computer-readable storage mediums, memory devices) can include computer-readable instructions 1006 that can be executed by the one or more processors 1002. The instructions 1006 can be software written in any suitable programming language or can be implemented in hardware. Additionally, or alternatively, the instructions 1006 can be executed in logically and/or virtually separate threads on processor(s) 1002.

For example, the memory 1004 on-board the vehicle 102 can store instructions 1006 that when executed by the one or more processors 1002 cause the one or more processors 1002 (e.g., in the vehicle computing system 112) to perform operations such as any of the operations and functions of the computing device(s) 1001 and/or vehicle computing system 112, any of the operations and functions for which the vehicle computing system 112 is configured, and/or any other operations and functions described herein.

The memory 1004 can store data 1008 that can be obtained (e.g., received, accessed, written, manipulated, created, generated, etc.) and/or stored. The data 1008 can include, for instance, services data (e.g., assignment data, route data, user data, etc.), sensor data, map data, perception data, prediction data, motion planning data, object states and/or state data, object motion trajectories, feedback data, fault data, log data, and/or other data/information as described herein. In some implementations, the computing device(s) 1001 can obtain data from one or more memories that are remote from the autonomous vehicle 102.

The computing device(s) 1001 can also include a communication interface 1010 used to communicate with one or more other system(s) (e.g., the remote computing system 1020). The communication interface 1010 can include any circuits, components, software, etc. for communicating via one or more networks (e.g., network(s) 1040). In some implementations, the communication interface 1010 can include, for example, one or more of a communications controller, receiver, transceiver, transmitter, port, conductors, software, and/or hardware for communicating data.

The remote computing system 1020 can include one or more computing device(s) 1021. The computing device(s) 1021 can include one or more processors 1022 and at least one memory 1024. The one or more processors 1022 can be any suitable processing device (e.g., a processor core, a microprocessor, an ASIC, a FPGA, a controller, a microcontroller, etc.) and can be one processor or a plurality of processors that are operatively connected. The memory 1024 can include one or more tangible, non-transitory computer-readable storage media, such as RAM, ROM, EEPROM, EPROM, one or more memory devices, flash memory devices, data registers, etc., and combinations thereof.

The memory 1024 can store information that can be accessed by the one or more processors 1022. For instance, the memory 1024 (e.g., one or more tangible, non-transitory computer-readable storage media, one or more memory devices, etc.) can include computer-readable instructions 1026 that can be executed by the one or more processors 1022. The instructions 1026 can be software written in any suitable programming language or can be implemented in hardware. Additionally, or alternatively, the instructions 1026 can be executed in logically and/or virtually separate threads on processor(s) 1022.

For example, the memory 1024 can store instructions 1026 that when executed by the one or more processors 1022 cause the one or more processors 1022 to perform operations such as any of the operations and functions of the operations computing system 104, the remote computing system 106, the remote computing system 1020 and/or computing device(s) 1021 or for which any of these computing systems are configured, as described herein, and/or any other operations and functions described herein.

The memory 1024 can store data 1028 that can be obtained and/or stored. The data 1028 can include, for instance, services data (e.g., assignment data, route data, user data etc.), data associated with autonomous vehicles (e.g., vehicle data, maintenance data, ownership data, sensor data, map data, perception data, prediction data, motion planning data, object states and/or state data, object motion trajectories, feedback data, fault data, log data, etc.), third-party entity data, inventory data, scheduling data, log data, attribute data, scenario data, simulation data (e.g., simulation control data, simulation result data, etc.), testing data, training data, integration data, libraries, user data, and/or other data/information as described herein. In some implementations, the computing device(s) 1021 can obtain data from one or more memories that are remote from the remote computing system 1020.

The computing device(s) 1021 can also include a communication interface 1030 used to communicate with one or more other system(s) (e.g., the vehicle computing system 112, remote computing systems, etc.). The communication interface 1030 can include any circuits, components, software, etc. for communicating via one or more networks (e.g., network(s) 1040). In some implementations, the communication interface 1030 can include, for example, one or more of a communications controller, receiver, transceiver, transmitter, port, conductors, software, and/or hardware for communicating data.

The network(s) 1040 can be any type of network or combination of networks that allows for communication between devices. In some embodiments, the network(s) 1040 can include one or more of a local area network, wide area network, the Internet, secure network, cellular network, mesh network, peer-to-peer communication link, and/or some combination thereof, and can include any number of wired or wireless links. Communication over the network(s) 1040 can be accomplished, for instance, via a communication interface using any type of protocol, protection scheme, encoding, format, packaging, etc.

Computing tasks discussed herein as being performed at computing device(s) remote from the autonomous vehicle can instead be performed at the autonomous vehicle (e.g., via the vehicle computing system), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method for autonomous vehicle service assignment simulation, the method comprising:
identifying, by the computer system, a predefined scenario for an autonomous vehicle to be tested within the simulation;
obtaining by the computing system, data associated with a simulation of the autonomous vehicle to use within a simulation environment based at least in part on the predefined scenario;
initiating, by the computing system, a simulation of the predefined scenario using the data associated with the simulated autonomous vehicle to perform the predefined scenario within the simulation environment;
providing, by the computing system, the simulated autonomous vehicle access to one or more services of one or more backend systems of the service entity during the simulation;
receiving, by the computer system, one or more simulated events, the simulated events enabling the simulated autonomous vehicle to attempt to complete the predefined scenario; and
determining, by the computer system, based on one or more criteria whether the simulated autonomous vehicle has successfully completed the predefined scenario.

2. The computer-implemented method of claim 1, wherein the predefined scenario is represented as directed graph including a plurality of nodes connected by one or more edges.

3. The computer-implemented method of claim 2, wherein each node represents a state in the predefined scenario and each edge of the one or more edges is associated with a respective simulated event, such that receiving a simulated event causes the simulation of the predefined scenario to transition from a first state to a second state of the directed graph.

4. The computer-implemented method of claim 3, further comprising:
determining whether the second state is a terminal state;
in response to determining that the second state is the terminal state, ceasing to perform simulation of the predefined scenario; and
determining whether the autonomous vehicle has successfully completed the predefined scenario comprises determining whether the autonomous vehicle has successfully completed the identified predefined scenario based on a representation of the terminal state.

5. The computer-implemented method of claim 3, wherein each state is associated with one or more expected events and each event has one or more associated event parameters, the method further comprising:
in response to receiving an event, accessing event parameter data for the event;
determining, based on the event parameter data, whether the event is an expected event; and
in response to determining that the event is an expected event, transitioning from a current state to a failure state.

6. The computer-implemented method of claim 1, wherein the predefined scenario includes a series of states, each state associated with one or more state requirements.

7. The computer-implemented method of claim 6, wherein the state requirements include preconditions that must be met before the state is considered successfully completed.

8. The computer-implemented method of claim 1, wherein the predefined scenario was received from a third-party computing system prior to being identified for use in a simulation.

9. The computer-implemented method of claim 1, wherein determining whether the autonomous vehicle has successfully completed the identified predefined scenario includes:
determining whether the simulation has reached a terminal state; and
in response to determining that the simulation has reached a terminal state, determining whether the terminal state is associated with a successful completion of the predefined scenario.

10. The computer-implemented method of claim 1, wherein the simulated events are received based on input selected by a user.

11. The computer-implemented method of claim 1, wherein the simulated events are generated automatically by the computer system as part of the predefined scenario.

12. The computer-implemented method of claim 1, wherein the simulation environment is a simulation sandbox that is configured to isolate the simulation from a real-world service assignment allocation by the service entity.

13. The computer implemented method of claim 1, further comprising:
in response to identifying the predefined scenario, accessing scenario data from a scenario repository.

14. The computer implemented method of claim 1, wherein the one or more services includes one of transportation services, courier services, or delivery services.

15. A computing system comprising:
one or more processors; and
one or more tangible, non-transitory, computer readable media that collectively store instructions that when executed by the one or more processors cause the computing system to perform operations comprising:
generating a simulation environment for a simulation of a predefined scenario associated with a service entity;
obtaining data describing a simulated autonomous vehicle within the simulation environment, wherein the simulated autonomous vehicle and the simulated environment begin in an initial state of the predefined scenario;
receiving a simulated event;
in response to receiving a simulated event, transitioning from the initial state of the predefined scenario to a second state of the predefined scenario; and
determining whether the second state of the predefined scenario is a terminal state; and
in response to determining that the second state of the predefined scenario is the terminal state, recording simulation data associated with the simulated autonomous vehicle and the simulation environment.

16. The computer system of claim 15, further comprising:
in response to determining that the second state of the predefined scenario is the terminal state, recording simulation data associated with the simulated autonomous vehicle and the simulation environment.

17. The computer system of claim 15, further comprising:
in response to determining that the second state of the predefined scenario is not the terminal state, continuing to receive events until the terminal state is reached.

18. The computer system of claim 15, further comprising:
providing, by the computing system, data indicative of the simulation for display via a user interface of a display device.

19. The computer system of claim 14, wherein simulated events are received based on input selected by a user.

20. A non-transitory computer-readable medium storing instruction that, when executed by one or more computing devices, cause the one or more computing devices to perform operations, the operations comprising:
obtaining data associated with a simulated autonomous vehicle within a simulation environment based at least in part on the predefined scenario;
identifying a predefined scenario for the autonomous vehicle to be tested within the simulation, wherein the predefined scenario includes a series of states, each state is associated with one or more state requirements, and the state requirements include preconditions that must be met before the state is considered successfully completed;
initiating a simulation of the predefined scenario using the data associated with the simulated autonomous vehicle to perform the predefined scenario within the simulation environment;
receiving one or more simulated events, the simulated events enabling the simulated autonomous vehicle to attempt to complete the predefined scenario; and
determining based on one or more criteria whether the autonomous vehicle has successfully completed the predefined scenario.
